(19) United States
(12) Patent Application Publication
(10) Pub. No.: US 2025/0304486 A1
(43) Pub. Date: Oct. 2, 2025

(54) OPTICAL FIBER PREFORM MANUFACTURING METHOD AND OPTICAL FIBER MANUFACTURING METHOD

(71) Applicant: FURUKAWA ELECTRIC CO., LTD., Tokyo (JP)

(72) Inventors: Kazunori MUKASA, Tokyo (JP); Osanobu FUKUO, Tokyo (JP); Keiichi AISO, Tokyo (JP); Shugo TAKEUCHI, Tokyo (JP)

(73) Assignee: FURUKAWA ELECTRIC CO., LTD., Tokyo (JP)

(21) Appl. No.: 19/238,812

(22) Filed: Jun. 16, 2025

Related U.S. Application Data
(63) Continuation of application No. PCT/JP2024/000569, filed on Jan. 12, 2024.

(30) Foreign Application Priority Data
Jan. 27, 2023 (JP) 2023-011074

(51) Int. Cl. C03B 37/012; C03B 37/027

(52) U.S. Cl. CPC C03B 37/01211; C03B 37/027

(57) ABSTRACT

An optical fiber preform manufacturing method includes: a core portion formation step of forming a core portion; and a cladding portion formation step of forming a cladding portion on an outer periphery of the core portion. The core portion formation step includes: a placement step of placing a first member doped with an alkaline element and a second member not doped with the alkaline element such that no contact is made therebetween and one member encloses another member; and a heat treatment step of heating the first member and the second member in a mutually non-contacting state, and scattering the alkaline element from the first member onto the second member. In the cladding portion formation step, the second member that has been doped with the alkaline element during the heat treatment process is used as at least some part of the core portion.

This application is a continuation of International Application No. PCT/JP2024/000569, filed on Jan. 12, 2024 which claims the benefit of priority of the prior Japanese Patent Application No. 2023-011074, filed on Jan. 27, 2023, the entire contents of which are incorporated herein by reference.

### BACKGROUND

The present disclosure relates to an optical fiber preform manufacturing method and an optical fiber manufacturing method.

As a technique for reducing the transmission loss in an optical fiber that is made of glass, a technique is known in which the core portion is doped with an alkaline element. In order to manufacture an optical fiber in which the core portion is doped with an alkaline element, techniques have been disclosed for manufacturing an optical fiber preform in which the core portion is doped with an alkaline element (refer to JP 2005-537210 A, JP 2007-513862 A and JP 2007-516929 A). In JP 2005-537210 A, JP 2007-513862 A and JP 2007-516929 A, a compound containing an alkaline element is heated and is turned into gas. Then, the gas is carried to a glass member using a carrier gas, and the glass member is doped with the gas-phase alkaline element.

### SUMMARY

In the techniques disclosed in JP 2005-537210 A, JP 2007-513862 A and JP 2007-516929 A, not only a special device is required for doping a glass member with an alkaline element, but the process is also complex.

There is a need for an optical fiber preform manufacturing method and an optical fiber manufacturing method that would enable doping a glass member with an alkaline element by implementing simple processes and using simple devices.

According to one aspect of the present disclosure, there is provided an optical fiber preform manufacturing method for manufacturing an optical fiber preform including a core portion, and a cladding portion enclosing an outer periphery of the core portion and having a lower refractive index than a maximum refractive index of the core portion, the optical fiber preform manufacturing method including: a core portion formation step of forming the core portion; and a cladding portion formation step of forming the cladding portion on the outer periphery of the core portion, wherein the core portion formation step includes a placement step of placing a first member that is in solid state and doped with an alkaline element and a second member that is in solid state and not doped with the alkaline element, wherein one member of the first and the second members has a rod-shape and an other member of the first and the second members has a shape configured to enclose the one member, and wherein the first member and the second member are placed such that no contact is made therebetween and the other member encloses the one member, a heat treatment step of heating the first member and the second member in a mutually non-contacting state, and scattering the alkaline element from the first member onto the second member, and in the cladding portion formation step, the second member that has been doped with the alkaline element during the heat treatment process is used as at least some part of the core portion.

### BRIEF DESCRIPTION OF THE DRAWINGS

FIG. 1 is a schematic cross-sectional view of an optical fiber preform that is manufactured according to an optical fiber preform manufacturing method according to a first embodiment;

FIG. 2 is a flowchart for explaining the optical fiber preform manufacturing method according to the first embodiment;

FIG. 3 is a diagram for explaining about a preparation process, a placement process, and a heat treatment process;

FIG. 4 is a diagram for explaining about a collapse causing process;

FIG. 5 is a diagram for explaining an optical fiber preform manufacturing method according to a second embodiment; and

FIG. 6 is a flowchart for explaining an optical fiber manufacturing method according to a third embodiment.

### DETAILED DESCRIPTION

Exemplary embodiments are described below in detail with reference to the accompanying drawings. However, the present disclosure is not limited by the embodiments described below. In the drawings, identical or corresponding constituent elements are referred to by the same reference numerals, and their explanation is not given repeatedly. Moreover, in the present written description, the cutoff wavelength or the effective cutoff wavelength implies the cable cutoff wavelength defined in ITU-T G.650.1 of the International Telecommunications Union (ITU). Regarding the other terms that are not specifically defined in the present written description, it is assumed that the definitions and the measurement methods given in G.650.1 and G.650.2 are followed.

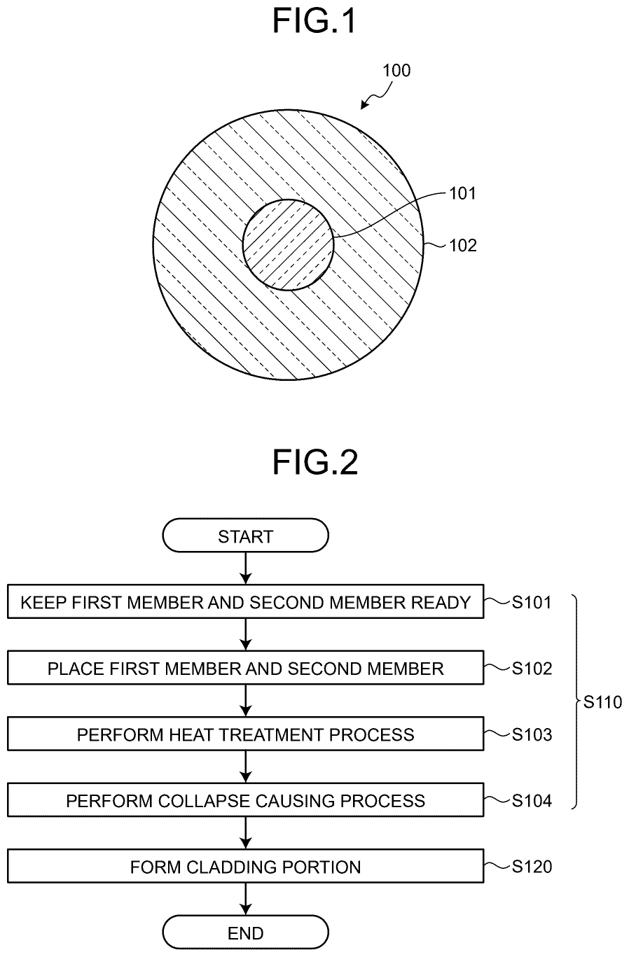

FIG. 1 is a schematic cross-sectional view of an optical fiber preform that is manufactured according to an optical fiber preform manufacturing method according to a first embodiment. An optical fiber preform 100 includes a core portion 101 that is made of glass such as silica based glass; and includes a cladding portion 102 that is made of glass such as silica based glass having a lower refractive index than the maximum refractive index of the core portion and that encloses the outer periphery of the core portion 101.

The core portion 101 is doped with an alkaline element. The alkaline element includes at least one type of element selected from lithium (Li), natrium (Na), potassium (K), and rubidium (Rb). Moreover, the core portion 101 may also contain some other dopant used in optical fibers, such as germanium (Ge), fluorine (Fe), chlorine (Cl), or aluminum (Al).

FIG. 2 is a flowchart for explaining the optical fiber preform manufacturing method according to the first embodiment. The optical fiber preform manufacturing method according to the first embodiment includes a core portion formation process and a cladding portion formation process.

At Step S110, the core portion formation process is performed in which the core portion 101 is formed. At Step S120, the cladding portion formation process is performed in which the cladding portion 102 is formed to enclose the outer periphery of the core portion 101. With that, the optical fiber preform 100 gets manufactured.

Given below is the specific explanation about the core portion formation process and the cladding portion formation process. The core portion formation process includes a preparation process, a placement process, a heat treatment process, and a collapse causing process.

The explanation about the preparation process, the placement process, the heat treatment process, and the collapse causing process is given with reference to FIGS. 2, 3, and 4. At Step S101, the preparation process is performed in which a first member 1 and a second member 2 are readied.

The first member 1 is a solid-state member doped with an alkaline element. In the first embodiment, the first member 1 is rod-shaped and has a circular cross-sectional surface. Moreover, the first member 1 is made of glass such as silica based glass. Alternatively, the first member 1 may be made of an unsintered material such as a gel. Such an unsintered material is also called a precursor to glass. If the first member 1 is manufactured according to the vapor axial deposition (VAD) method or the modified chemical vapor deposition (MCVD) method, then it becomes possible to obtain a glass member having high purity. Alternatively, the first member 1 may be readied according to some other method such as the sol-gel method, the sand method, or the extrusion molding method in which relatively complex processes or time-consuming processes are fewer. Meanwhile, the first member 1 need not always have high purity, and may contain various impurities. Herein, the first member 1 represents an example of “one member” that, from among a first member and a second member, is a rod-shaped member.

Regarding the method for doping the first member 1 with an alkaline element, it is possible to implement the gas-phase method if the first member 1 is to be manufactured according to the VAD method or the MCVD method. On the other hand, if the first member 1 is to be manufactured according to the sol-gel method, the sand method, or the extrusion molding method; then a material containing an alkaline element may be mixed with the raw material.

The second member 2 is a solid-state member that is not doped with an alkaline element. In the first embodiment, the second member 2 has the shape of a circular pipe with the inner diameter large enough to allow insertion of the first member 1. The second member 2 is made of glass such as silica based glass. Since the second member 2 later serves as the core portion, it is desirable that the second member 2 has high purity. Thus, it is desirable to manufacture the second member 2 according to the VAD method or the MCVD method. The second member 2 represents an example of “other member” that, from among the first member and the second member, has the shape enabling enclosure of the “one member”.

At Step S102, the placement process is performed in which the first member 1 and the second member 2 are placed in such a way that no contact is made therebetween and that the second member 2 encloses the first member 1.

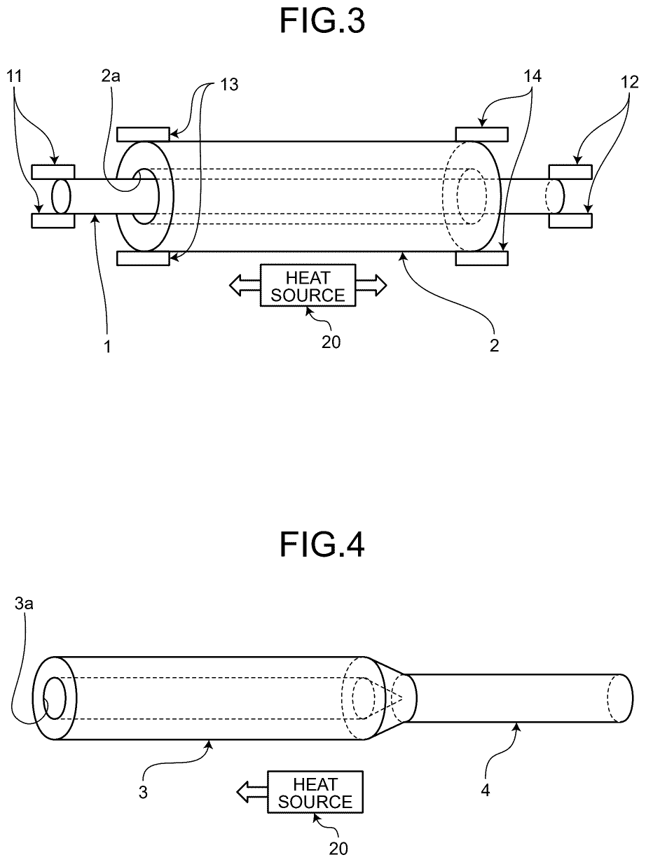

In the first embodiment, as illustrated in FIG. 3, the first member 1 is inserted into a hole 3a formed in the second member 2, so that the second member 2 encloses the first member 1. Then, in that state, both ends of the first member 1 are grasped and fixed using grasping mechanisms 11 and 12 of a heat treatment device; both ends of the second member 2 are grasped and fixed using grasping mechanisms 13 and 14; and the first member 1 and the second member 2 are fixed in such a way that no contact is made therebetween. Herein, the grasping mechanisms 11, 12, 13, and 14 represent examples of a fixing mechanism.

At Step S103, the heat treatment process is performed in which the first member 1 and the second member 2 are heated in a mutually non-contacting state and in which the alkaline element is scattered from the first member 1 onto the second member 2 due to heating.

In the first embodiment, as illustrated in FIG. 3, the heat treatment is performed by moving a heat source 20, such as a flame included in the heat treatment device, along the longitudinal direction of the first member 1 and the second member 2. As a result, the first member 1 gets heated, the alkaline element scatters from the first member 1 onto the second member 2, and the second member 2 gets doped with the alkaline element.

Regarding the conditions for heat treatment, it is preferable to set the temperature and the time in such a way that the first member 1 and the second member 2 do not undergo deformation due to melting. For example, when the first member 1 and the second member 2 are made of silica based glass, if the temperature is set between 800° C. and 1500° C., then the heating may be performed for a long period of time of three hours or more. In the case of high-temperature treatment having the temperature equal to or greater than 1600° C., the period of time for continuously heating the same area is preferably equal to or shorter than one hour. Meanwhile, there is no particular restriction on the environment for performing the heat treatment. For example, atmospheric air or an inert gas serves as the environment.

The grasping mechanisms 11, 12, 13, and 14 may be configured to make either one or both of the first member 1 and the second member 2 to be axially rotatable. Due to such rotation, it becomes easier to perform uniform heat treatment around the axis. Alternatively, instead of axially rotating either one or both of the first member 1 and the second member 2, the heat source 20 may be rotated around the second member 2.

When the distance between the first member 1 and the second member 2 is short, the scattering of the alkaline element from the first member 1 onto the second member 2 occurs easily, and hence the doping amount of the second member 2 may be increased. In that regard, the distance between the first member 1 and the second member 2 is desirably equal to or shorter than thrice the diameter of the first member 1, or more desirably equal to or shorter than twice the diameter of the first member 1, or still more desirably equal to or shorter than 1.5 times the diameter of the first member 1. However, when the distance between the first member 1 and the second member 2 is too short, in case either one or both of the first member 1 and the second member 2 undergo deformation due to heating, there is a risk of a contact occurring therebetween. Hence, it is desirable to maintain a certain distance. In that regard, the distance between the first member 1 and the second member 2 is desirably equal to or greater than 1.05 times the diameter of the first member 1.

At Step S104, the collapse causing process is performed in which the second member 2 doped with the alkaline element is made to collapse. That is, in the first embodiment, since the second member 2 is cylindrical in shape, it is desirable to make the second member 2 collapse in such a way that the hole 2a is eliminated.

In the first embodiment, as illustrated in FIG. 4, the collapse causing process is performed by moving the heat source 20, such as a flame, along the longitudinal direction of a second member 3 that is formed as a result of doping the second member 2 with the alkaline element. As a result, a hole 3a of the second member 3 is eliminated, and a rod-shaped second member 4 is obtained.

Given below is the explanation of the cladding portion formation process. In the cladding portion formation process, doping of the alkaline element is performed according to the heat treatment process; and the second member 4, which is formed in the rod shape according to the collapse causing process, is used as at least some part of the core portion 101. In the first embodiment, the second member 4 is used without modification as the core portion 101.

In the cladding portion formation process, a known method such as the outside vapor deposition (OVD) method or the jacketing method is implemented and the cladding portion 102 is formed in the second member 4. As a result, the optical fiber preform 100 gets manufactured.

According to the first embodiment described above, as a result of performing simple processes such as the preparation process, the placement process, the heat treatment process, and the collapse causing process using simple devices, it becomes possible to manufacture the optical fiber preform 100 in which the core portion 101 is doped with an alkaline element.

Particularly, according to the first embodiment, the first member 1 and the second member 2 are heated in a mutually non-contacting state, and the alkaline element is scattered from the first member 1 onto the second member 2 due to heating. As a result, as compared to the case in which the first member 1 and the second member 2 are heated while being in contact with each other and the alkaline element is scattered from the first member 1 onto the second member 2, it is not required to perform a process for separating the first member 1 and the second member 2 after the scattering (for example, a cumbersome process such as the hole drilling method). Hence, the processes become significantly simpler. Moreover, when the first member 1 and the second member 2 are integrated; in the separation process, some part of the second member 2 is scraped off thereby resulting in a missing part, the quantity of the second member 2 that may be used as the core portion 101 becomes smaller. In contrast, in the first embodiment, since there is no such missing part, the second member 2 may be used in an effective manner. Moreover, when the first member 1 and the second member 2 are not making contact with each other, if the first member 1 contains an element such as iron (Fe) that is difficult to scatter or spread as compared to an alkaline element, the second member 2 does not get easily doped with that element as compared to the case in which the first member 1 and the second member 2 are in contact with each other. Thus, there is no need for the first member 1 to have high purity. Hence, the first member 1 may be readied at a low cost and with ease.

As a different optical fiber preform manufacturing method for manufacturing the optical fiber preform 100 illustrated in FIG. 1, the following explanation is given about an optical fiber preform manufacturing method according to a second embodiment. The second embodiment may be implemented by following an identical flow to the flow illustrated in FIG. 2 according to the first embodiment. However, the first member and the second member to be readied are different than the first embodiment. Moreover, in the second embodiment, the collapse causing process becomes redundant as explained later.

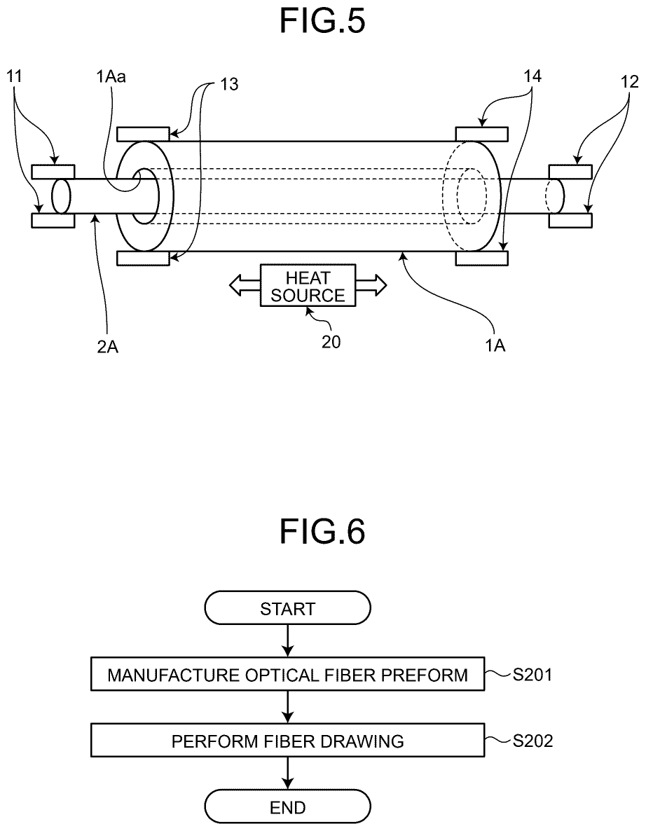

FIG. 5 is a diagram for explaining the optical fiber preform manufacturing method according to the second embodiment. As illustrated in FIG. 5, in the second embodiment, a first member 1A and a second member 2A are readied.

The first member 1A is a solid-state member that is doped with an alkaline member. In the second embodiment, the first member 1A has the shape of a circular pipe with the inner diameter large enough to allow insertion of the second member 2A. The second member 2A is solid-state member that is not doped with an alkaline element. In the second embodiment, the second member 2A is rod-shaped and has a circular cross-sectional surface. The first member 1A represents an example of “other member” that, from among a first member and a second member, has the shape enabling enclosure of the “one member”. The second member 2A represents an example of “one member” that, from among the first member and the second member, is a rod-shaped member.

In an identical manner to the first member 1, the first member 1A is made of glass or a precursor to glass. Moreover, in an identical manner to the second member 2, the second member 2A is made of glass.

In the second embodiment, after the preparation process is performed for readying the first member 1A and the second member 2A, the placement process is performed in which the first member 1A and the second member 2A are placed in such a way that no contact is made therebetween and that the first member 1A encloses the second member 2A. In the second embodiment, as illustrated in FIG. 5, the second member 2A is inserted into a hole 1Aa formed in the first member 1A, so that the first member 1A encloses the second member 2A. Then, in that state, both ends of the second member 2A are grasped and fixed using the grasping mechanisms 11 and 12; both ends of the first member 1A are grasped and fixed using the grasping mechanisms 13 and 14; and it is ensured that the first member 1A and the second member 2A do not make contact with each other.

Subsequently, using the heat source 20, the heat treatment process is performed in which the first member 1A and the second member 2A are heated in a mutually non-contacting state, and in which the alkaline element is scattered from the first member 1A onto the second member 2A due to heating. Thus, the first member 1A gets heated, the alkaline element scatters from the first member 1A onto the second member 2A, and the second member 2A gets doped with the alkaline element.

Herein, the conditions and the environment during the heat treatment process may be identical to the first embodiment. Moreover, regarding the axial rotation of either one or both of the first member 1A and the second member 2A and regarding the rotation of the heat source 20, the rotation may be identical to the first embodiment.

Also regarding the distance between the first member 1A and the second member 2A, in an identical manner to the first embodiment, the distance is desirably equal to or shorter than thrice the diameter of the second member 2A, or more desirably equal to or shorter than twice the diameter of the second member 2A, or is still more desirably equal to or shorter than 1.5 times the diameter of the second member 2A; and is desirably equal to or greater than 1.05 times the diameter of the second member 2A.

In the second embodiment, the second member 2A that gets doped with the alkaline element due to the heat treatment process is a rod-shaped member. Hence, without having to perform the collapse causing process, the cladding portion formation process identical to the first embodiment may be performed, so that the optical fiber preform 100 is manufactured.

According to the second embodiment described above, the optical fiber preform 100 in which the core portion 101 is doped with an alkaline element may be manufactured according to simpler processes and using simpler devices as compared to the first embodiment.

As a third embodiment, the explanation is given about an optical fiber manufacturing method for manufacturing an optical fiber using the optical fiber preform 100 illustrated in FIG. 1. FIG. 6 is a flowchart for explaining the optical fiber manufacturing method according to the third embodiment.

In the third embodiment, at Step S201, as an optical fiber preform manufacturing process, the optical fiber preform manufacturing method according to the first embodiment or the second embodiment is implemented, and the optical fiber preform 100 is manufactured. Then, at Step S202, a fiber drawing process is performed for drawing the optical fiber preform 100 that has been manufactured. The fiber drawing process may be performed using a known fiber drawing device.

According to the third embodiment described above, an optical fiber having the core region doped with an alkaline element may be manufactured by implementing simple processes and using simple devices.

As a working example and a comparison example, an optical fiber preform was manufactured as explained below, and an optical fiber was manufactured from that optical fiber preform.

As the second member, a silica glass rod made of highly pure silica glass was manufactured according to the VAD method. Then, the second member was doped with 500 ppm of Cl₂. The second member had the outer diameter equal to 35 mm and the length equal to 1000 mm.

Moreover, the first member having the shape of a circular pipe was manufactured and readied. More particularly, tetraethoxysilane (TEOS), ethanol, water, ammonia, and K₂SiO₃ were added into a container having the shape of a circular pipe; the sol-gel method was implemented to generate a silica drying gel having the shape of a circular pipe and doped with potassium (K); and the silica drying gel was treated as the first member. Regarding the potassium concentration in the first member, although a concentration distribution was seen depending on the area, the average concentration was equal to 1000 ppm. The first member had the inner diameter equal to 40 mm, the outer diameter equal to 50 mm, and the length equal to 800 mm.

Subsequently, the first member doped with potassium was grasped and fixed using a grasping chuck of a heat treatment device. The second member was inserted into the hole formed in the first member, and then the second member was grasped and fixed using a grasping chuck of the heat treatment device.

Subsequently, while axially rotating the first member and the second member, they were burnt using the flame of an oxyhydrogen burner and heat treatment was performed at the temperature of about 1800° C. At that time, the oxyhydrogen burner was moved in the longitudinal direction of the first member, and thus it was ensured that the same areas of the first member and the second member were not continuously burnt. With that, the first member and the second member were prevented from deformation.

However, a restriction was placed on the movement range of the oxyhydrogen burner in the longitudinal direction and it was ensured that the portions subjected to heat treatment (heat-treated portions) and the portions not subjected to heat treatment (heat-untreated portions) were formed in the longitudinal direction in the first member and the second member.

After the heat treatment, the second member was taken out from the first member, and some part of the heat-treated portion of the second member was cut and analyzed. At that time, it was confirmed that the heat-treated portion was doped with potassium having a concentration distribution exhibiting the peak on the outer periphery side. The peak value of the concentration was equal to 300 ppm.

Subsequently, the jacketing process was performed on the second member to form the cladding portion, and the optical fiber preform was manufactured. Then, from the optical fiber preform, an optical fiber was manufactured. In the optical fiber manufactured as explained above, it is believed that, due to the heating during fiber drawing, potassium gets scattered onto the core portion and onto the inside region of the cladding portion and has a relatively uniform concentration. Moreover, during fiber drawing, since there is a drop in the fictive temperature between the core portion and the inside region of the cladding portion, it is believed that the transmission loss of the optical fiber is reduced.

In the optical fiber manufactured as explained above, a potassium-doped portion was included that was manufactured from the second member doped with potassium as a result of performing the heat treatment, and a potassium-undoped portion was included that was manufactured from the second member not doped with potassium as a result of not performing the heat treatment. Then, some part of the potassium-doped portion was cut and was treated as the optical fiber according to the working example; and some part of the potassium-undoped portion was cut and was treated as the optical fiber according to the comparison example.

Subsequently, the optical properties of the optical fiber according to the working example and the optical properties of the optical fiber according to the comparison example were measured. The measurement result is given below in Table 1. In Table 1, “Aeff” represents the effective core sectional area, and “λcc” represents the cutoff wavelength. In the optical fiber according to the working example and the optical fiber according to the comparison example, the relative refractive-index difference and the core diameter is same because the same optical fiber preform was used in the manufacturing.

Hence, the effective core sectional area and the cutoff wavelength were substantially same. However, as compared to the optical fiber according to the comparison example, the transmission loss in the optical fiber according to the working example was lower by about 0.02 dB/km. That is believed to be due to the fact that the optical fiber according to the working example was properly doped with potassium.

TABLE 1

| | Transmission | | |
|---|---|---|---|
| | loss [dB/km] | Aeff [μm²] | λcc |
| | @ 1.55 μm | @ 1.55 μm | [nm] |
| Comparison example | 0.176 | 80.2 | 1425 |
| Working example | 0.155 | 80.1 | 1423 |

Meanwhile, in the embodiments described above, the heat treatment process is performed by moving the heat source 20. Alternatively, the first member and the second member may be inserted into a heat treatment device such as an oven, and a heat treatment process may be performed in which the first member and the second member are heated in whole.

Moreover, in the embodiments described above, the core portion formation process may include a plurality of batches of the placement process and the heat treatment process, and a plurality of batches of the placement process and the heat treatment process may be implemented using a single first member. For example, the placement process and the heat treatment process performed using the first member 1 and the second member 2 according to the first embodiment are treated as a first batch. Then, if the first member 1 still remains doped with a sufficient concentration of the alkaline element, the first member 1 and a different second member than the second member 2 are readied and are subjected to a second batch of the placement process and the heat treatment process. Thereafter, if the first member 1 still remains doped with a sufficient concentration of the alkaline element, the first member 1 and a still different second member may be readied and may be subjected to still another batch of the placement process and the heat treatment process. With that, the first member 1 may be utilized in an effective manner and a plurality of second members doped with the alkaline element may be manufactured.

Meanwhile, in the embodiments described above, the second member 2 and the first member 1A have the shape of a circular pipe. However, that is not the only possible shape. For example, as the second member 2 and the first member 1A, a plurality of plate-like members may be combined into a shape that enables enclosure of the first member 1 and the second member 2A, respectively. Moreover, in the optical fiber preform manufacturing method according to the first embodiment, the second member 4 is used without modification as the core portion 101. Alternatively, the second member may be used as some part of the core portion and the cladding portion.

According to the present disclosure, a glass member may be doped with an alkaline element by implementing simple processes and using simple devices.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical fiber preform manufacturing method for manufacturing an optical fiber preform including a core portion, and a cladding portion enclosing an outer periphery of the core portion and having a lower refractive index than a maximum refractive index of the core portion, the optical fiber preform manufacturing method comprising:
a core portion formation step of forming the core portion; and
a cladding portion formation step of forming the cladding portion on the outer periphery of the core portion, wherein
the core portion formation step includes
a placement step of placing a first member that is in solid state and doped with an alkaline element and a second member that is in solid state and not doped with the alkaline element, wherein one member of the first and the second members has a rod-shape and an other member of the first and the second members has a shape configured to enclose the one member, and wherein the first member and the second member are placed such that no contact is made therebetween and the other member encloses the one member,
a heat treatment step of
heating the first member and the second member in a mutually non-contacting state, and
scattering the alkaline element from the first member onto the second member, and
in the cladding portion formation step, the second member that has been doped with the alkaline element during the heat treatment process is used as at least some part of the core portion.

2. The optical fiber preform manufacturing method according to claim 1, wherein the first member and the second member are made of silica based glass.

3. The optical fiber preform manufacturing method according to claim 1, wherein the first member is made of a precursor to glass.

4. The optical fiber preform manufacturing method according to claim 1, wherein the alkaline element contains potassium.

5. The optical fiber preform manufacturing method according to claim 1, wherein
in the placement step, the first member and the second member are fixed in a mutually non-contacting state using a fixing mechanism, and
in the heat treatment step, heat treatment is performed at a temperature at which the first member and the second member do not melt.

6. The optical fiber preform manufacturing method according to claim 1, wherein
the second member has a shape configured to enclose the first member, and
the core portion formation step includes a collapse causing step of collapsing the second member having been doped with the alkaline element.

7. The optical fiber preform manufacturing method according to claim 1, wherein
the core portion formation step includes a plurality of batches of the placement step and the heat treatment step, and
a plurality of batches of the placement step and the heat treatment step is implemented using the first member.

8. An optical fiber manufacturing method comprising:
executing the optical fiber preform manufacturing method according claim 1; and
drawing an optical fiber from the manufactured optical fiber preform.
